(19) United States
(12) Patent Application Publication
(10) Pub. No.: US 2026/0092507 A1
(43) Pub. Date: Apr. 2, 2026

(54) AUTONOMOUS OIL- AND GAS-BEARING WELL KILLING DEVICE WITH FIRE-FIGHTING FUNCTION

(71) Applicant: Yuriy Aleksandrovich GABLIYA, g. Moscow (RU)

(72) Inventors: Evgenii Sergeevich KAPLUN, s. Malaya Tsarevshchina (RU); Anton Ivanovich ZUBENIA, g. Moscow (RU); Evgenii Nikolaevich SERCHUGOV, g. Moscow (RU)

(21) Appl. No.: 19/247,364

(22) Filed: Jun. 24, 2025

(30) Foreign Application Priority Data
Oct. 1, 2024 (RU) 2024129187

(51) Int. Cl. E21B 35/00; A62C 3/06; A62C 35/02

(52) U.S. Cl. CPC E21B 35/00; A62C 3/06; A62C 35/023

(57) ABSTRACT

The claimed invention relates to the field of safety in the oil and gas industry and can be used for prompt well killing, as well as for extinguishing wells or containers with petroleum products. The technical problem that the claimed solution shall solve involves improving safety when working on oil and gas wells. The technical result of the claimed invention is to enable the operation of an autonomous well killing device with fire-fighting function, initiated manually to kill the well or reacting to a fire at the wellhead using a thermochemical initiator while simultaneously creating pressure in the device body (vessel) to supply killing and fire extinguishing fluid that is sufficient to kill or extinguish the well. At the same time, a special feature of the autonomous well killing device with fire-fighting function is that it can be connected to an existing system of manifold pipes or pressure pipes of protected tanks and wells.

### BACKGROUND

The invention is categorized under devices permitting work in oil and gas industry and can be used for killing and simultaneous extinguishing of oil-bearing and gas-bearing wells, for example, through blowout preventer.

In the process of wellwork there may be cases of fluid, floating oil or gas kicks. During kicks the fluid can ignite which eliminates the possibility of pack-off and increases the chance of emergency situation at the wellhead. The existing methods of well killing suggest availability of killing pumps, for example LIA-320 units, and trip tanks with killing fluid, for example potassium chlorate water solution, in the well vicinity. The existing methods of extinguishing fires at wellheads also require an emergency crew call to extinguish fire at the well. At present moment there is no option of prompt extinguishing of wells by the efforts of crews located at the wellhead.

On a technical level, there is a firefighting method available for extinguishing fires indoors, in open spaces, as well as for extinguishing oil and gas wells, that involves breaking a container body filled with extinguishing liquid under sharp increase of internal pressure and dispersing said substance over the fire zone, with the container plastic body breaking and the fire-fighting agent dispersing due to the impact of electrical pulse discharge when the container is in the fire zone (patent RU 2210412 C2, publication date Aug. 20, 2003)

Another known device for extinguishing burning fountains on gas, oil and gas-oil wells can be used to extinguish fountain fires on gas, oil and gas-oil wells. The device contains a sealed container with chemical inhibitor, a cylinder gas source connected to the cavity of the specified container by a pipe aerator, which provides injection of fire extinguishing agent through a start-up device and a main pipeline. The pipeline is connected through a diaphragm, mechanical or electric valve with a nozzle spray. In this case, the nozzle has the form of a slot-shaped convergent tube with the angle of convergence in the vertical plane determined by the mentioned mathematical expression (RU 2534311 C1, publication date Nov. 27, 2014).

The closest analogue is a device for prevention of forest, industrial and emergency transport fires and laying of barrier strips (RU2701614C1 dated Sep. 30, 2019). The known device comprises a sealed body made of a composite material placed in a protective frame and containing components of a fire extinguishing agent, a means of mixing fire extinguishing agent components with subsequent foaming thereof, a means of creating pressure inside the body in the form of at least one solid-fuel gas generator with the possibility of creating pressure inside the body during combustion. The technical result to be achieved under this solution is to extinguish forest, industrial and emergency transport fires.

It's worth noting that the known solution has no possibility of initiation using a thermochemical initiator, which does not allow for autonomous start-up. Also, the known solution is not capable of creating a pressure above 1.6 MPa in the body, which excludes its use for extinguishing wells given that inside the wells and during fluid kicks pressures can reach up to 12 MPa-15 MPa.

The invention belongs to the field of foam fire extinguishing and is designed for extinguishing burning combustible and flammable liquids with large areas of combustion, as well as large storage tanks for petroleum products. The invention can be most successfully applied to extinguishing fires in large fuel storage tank fields, in various rooms, tanker holds, and large filling stations of combustible and flammable liquids. The device is a container filled with a foaming agent solution, a solid-fuel gas generator installed inside the container above the foaming agent level, and is based on the use of solid-fuel aerosol-forming compounds as a source of an aerosol flame retarder with the maximum specific extinguishing capacity among known extinguishing agents. The technical effect of the claimed device is to create an autonomous fire extinguishing device that treats the combustion source with a complex action of foam and inhibiting aerosol (patent RU 2622815 C1, publication date Jun. 20, 2017).

### SUMMARY OF THE INVENTION

The technical problem addressed by the claimed solution is the autonomous killing of wells (without power supply or pumping units) by a team working at the well and/or, in case of fire, the high-speed autonomous extinguishing of the well or autonomous extinguishing of tanks with oily liquids or petroleum products.

The technical result of the claimed invention is to enable the actuation and operation of an autonomous well killing device with fire-fighting function, capable of being initiated manually and/or of autonomously reacting to fire in the well or protected tank.

A special feature of an autonomous well killing device with fire-fighting function is that it can be connected to the supply lines of already existing refilling tanks or tanks for storing petroleum products in the preventer block circuit with a manifold line or other pressure lines.

The specified technical result is achieved in an autonomous well killing device for oil and gas wells with fire-fighting function, and in particular:
in the first version, the specified technical result is achieved by manufacturing an autonomous well killing device with fire-fighting function containing a sealed body (vessel) filled with well killing liquid that is simultaneously a fire extinguishing agent (FEA), for example, an aqueous solution of potassium chloride; at least one pyrotechnical gas-generating element (PGGE) containing a pyrotechnic composition; a thermochemical initiator connected to a gas-generating element (GGE) by a fire pulse transmission device capable of transmitting a fire pulse, and/or a mechanical initiator of a gas-generating element, and/or an electrical GGE initiator capable of igniting a pyrotechnic composition; as well as a connecting nipple of a sealed body (vessel) through which an autonomous well killing device with fire-fighting function can be connected by pipes, e.g., to a manifold line or another pressure line of storage tanks for petroleum-containing fluids or petroleum products;

In the second version, the specified technical result is achieved by manufacturing an autonomous well killing device with fire-fighting function, containing a sealed body (vessel) filled with well killing liquid that is simultaneously a fire extinguishing agent (FEA), for example, an aqueous solution of potassium chloride; at least one pyrotechnical gas-generating element (PGGE) containing a pyrotechnic composition; a thermochemical initiator connected to a gas-generating element (GGE) by a fire pulse transmission device capable of transmitting a fire pulse, and/or a mechanical initiator of a gas-generating element, and/or an electrical GGE initiator capable of igniting a pyrotechnic composition; as well as a connecting nipple of a sealed body (vessel) through which an autonomous well killing device with fire-fighting function can be connected by pipes, e.g., to a manifold line or other pressure line of storage tanks for petroleum-containing fluids or petroleum products; the device additionally contains a pressure regulator connected to a fire hose with a fire-hose monitor for extinguishing the adjoining territory;

In the third version, the specified technical result is achieved by manufacturing an autonomous well killing device with fire-fighting function, containing a sealed body (vessel) filled with well killing liquid that is simultaneously a fire extinguishing agent (FEA), for example, an aqueous solution of potassium chloride; at least one pyrotechnical gas-generating element (PGGE) containing a pyrotechnic composition and an additional compartment with surface acting agents (SAA), ejected from GGE by gases during pyrotechnic composition combustion into the sealed body (vessel); a thermochemical initiator connected to a gas-generating element (GGE) by a fire pulse transmission device capable of transmitting a fire pulse, and/or a mechanical initiator of the gas-generating element, and/or an electric initiator (GGE) capable of igniting the pyrotechnic composition; as well as a connecting nipple of a sealed body (of the vessel) through which an autonomous well killing device with fire-fighting function can be connected by pipes, e.g., to a manifold line or other pressure line of storage tanks for petroleum-containing fluids or petroleum products;

In the fourth version, the specified technical result is achieved by manufacturing an autonomous well killing device with fire-fighting function, containing a sealed body (vessel) filled with well killing liquid that is simultaneously a fire extinguishing agent (FEA), for example, an aqueous solution of potassium chloride; at least one pyrotechnical gas-generating element (PGGE) containing a pyrotechnic composition and an additional compartment with surface acting agents (SAA), ejected from GGE by gases during pyrotechnic composition combustion into the sealed body (vessel); a thermochemical initiator connected to a gas-generating element (GGE) by a fire pulse transmission device capable of transmitting a fire pulse, and/or a mechanical initiator of the gas-generating element, and/or an electric initiator (GGE) capable of igniting the pyrotechnic composition; as well as a connecting nipple of a sealed body (of the vessel) through which an autonomous well killing device with fire-fighting function can be connected by pipes, e.g., to a manifold line or other pressure line of storage tanks for petroleum-containing fluids or petroleum products; the device additionally contains a pressure regulator connected to a fire hose with a fire-hose monitor for extinguishing the adjoining territory.

The proposed device is an assembly unit made in a single body, and has a functional and constructive unity, therefore it can be claimed as a patent.

It is possible to install the proposed autonomous well killing device with fire-fighting function in open areas at some distance from protected facilities (wells, tanks with petroleum-containing fluids, or tanks with petroleum products). If necessary, an autonomous well killing device with fire-fighting function can be quickly moved and assembled near a new facility to be protected.

### BRIEF DESCRIPTION OF THE DRAWINGS

FIG. 1 depicts a diagram of a diagram and layout version of an autonomous well killing device with fire-fighting function according to embodiments of the invention;

FIG. 2 depicts a diagram and layout version of the autonomous well killing device with fire-fighting function in accordance with another embodiments of the invention;

FIG. 3 depicts a diagram and layout version of the autonomous well killing device with fire-fighting function in accordance with another embodiments of the invention;

FIG. 4 depicts a diagram and layout version of the autonomous well killing device with fire-fighting function in accordance with another embodiments of the invention;

FIG. 5 depicts a diagram and layout version of the autonomous well killing device with fire-fighting function in accordance with another embodiments of the invention; and

FIG. 6 depicts a diagram and layout version of the autonomous well killing device with fire-fighting function in accordance with another embodiments of the invention.

### DETAILED DESCRIPTION

In accordance with the first device version, information is given hereinunder about the preferred design of the device, which is not intended to limit the amount of protection requested, as defined by the characteristics of an independent formula item.

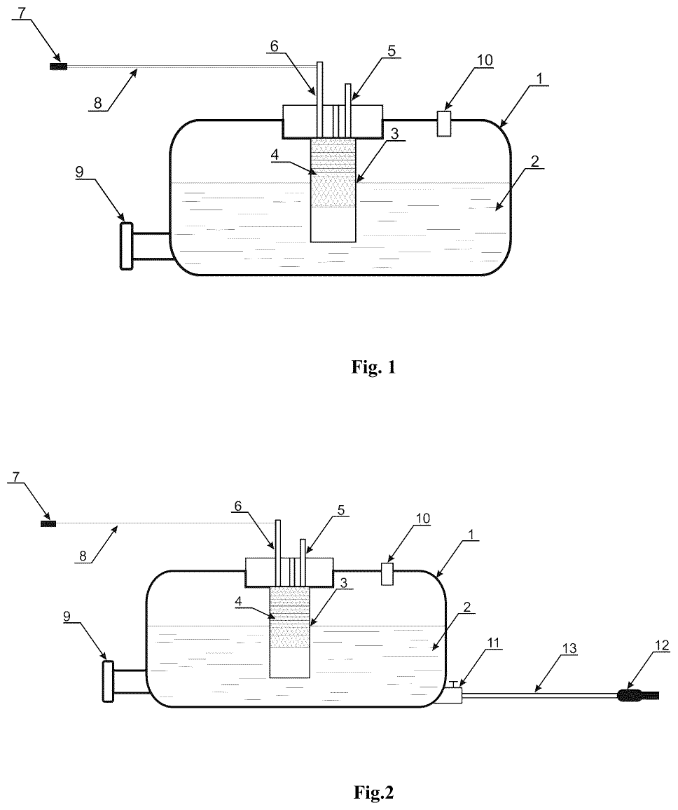

FIG. 1 shows a diagram and layout version of an autonomous well killing device with fire-fighting function, which allows to solve the problem of prompt well killing and, in case of fire, of autonomous unmanned extinguishing, where 1 is the device body (vessel), 2 is the killing and extinguishing liquid, for example, a saturated water solution of potassium salt (KCl), 3—a gas-generating element (GGE), which can be, for example, a body in the form of a pipe with holes on the side walls to discharge gas generated by a pyrotechnic gas generating charge, containing a pyrotechnical gas-generating composition (4) placed inside the device body (1), 4—pyrotechnical gas-generating composition, 5—mechanical GGE initiator, 6—pyrotechnic initiator, 7—thermosensitive element, 8—fire signal transmission line from the thermosensitive element to the pyrotechnic initiator, 9—connecting nipple, 10—pressure release valve.

In case of fluid kick at the wellhead, the working staff can shut off the preventer; however, it is still necessary to kill the well as soon as possible. This is especially true at remote wellheads, where access to special equipment, in particular, to LIA-320 cementing units and tanks with killing liquid, is difficult or impossible. Having decided on the prompt killing of a well, in order to prevent the development of an emergency situation, the personnel may come to the autonomous well killing device with fire-fighting function and manually initiate the mechanical GGE initiator (5), for example, by relieving the shear pin (not shown on FIG. 1). After the shear pin (not shown on FIG. 1) is relieved, the mechanical GGE initiator (5) is started forming a fire pulse to initiate the pyrotechnical gas-generating composition (4) located inside at least one gas-generating element (GGE) (3). During the combustion of the pyrotechnical gas-generating composition (4), there is an intense release of gases that fill the device body (vessel) (1) containing killing and fire extinguishing liquid (2). When the device body (vessel) (1) is filled with gases, the pressure inside it rises, for example, in the range from 1.0 MPa to 20.0 MPa, depending on the values of the required back pressure to create the necessary force during well killing. Pressure in the device body (vessel) (1) is regulated by means of the pressure release valve (10), which is pre-set to the required shutoff pressure within the range, for example, from 1.0 MPa to 20.0 MPa. During pressure increase in the device body (vessel) (1), the well killing fluid (2) begins to flow through the connecting nipple (9), for example, along the manifold line (not shown in FIG. 1), into the preventer, creating back pressure to the fluid and filling the wellbore space with killing and fire extinguishing fluid (2). The volume of killing and fire extinguishing fluid fed to the well can be in the range e.g. from 1.0 m³ to 20.0 m³.

If it was not possible to close the preventer during the emergency situation and the fluid ejected from the well through the preventer under pressure has ignited, a pre-installed thermosensitive element (7) connected to a pyrotechnic initiator (6) via a fire pulse transmission line (8) is triggered in the area of preventer location. Fire pulse rate can reach the speed of e.g. 2000-4000 meters per second. The ignition temperature of the thermosensitive element (7) can be, for example, 173° C. After the fire pulse is transmitted to the pyrotechnic initiator (6), the pyrotechnic composition ignites in at least one gas-generating element (GGE) (3). During the combustion of the pyrotechnical gas-generating composition, there is an intense release of gases (within 10-20 seconds) that fill the device body (vessel) (1) containing killing and extinguishing fluid (2). When the device body (vessel) (1) is filled with gases, the inside pressure rises, for example, in the range from 1.0 MPa to 20.0 MPa, depending on the values of the required back pressure to create the necessary force to extinguish the well. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing fluid (2) performs the functions of the fire extinguishing agent (FEA) and flows through the connecting nipple (9), for example, along the manifold line (not shown in FIG. 1) into the preventer, creating back pressure to the fluid, interrupting the release of the fluid through the open channel of the preventer (not show in FIG. 1) and filling the inner volume of the preventer, which leads to guaranteed extinguishing of the well. The volume of the killing fluid acting as the fire extinguishing agent (FEA) supplied to the well for extinguishing can be, for example, in the range from 1.0 m³ to 20.0 m³. The intensity of supply of the killing and extinguishing liquid (2), which performs the function of the fire extinguishing agent (FEA), supplied to the well to be killed can be in the range e.g. from 0.1 m³ to 0.5 m³ per second.

The device in the first version additionally contains an electrical initiator. It should be noted that the electric initiator looks like a bridge in the form of a thin wire made of metal with high resistance, attached to the contacts of the electric initiator, which is coated with a pyrotechnical grease that can easily ignite when heated and is able to give a thermal pulse of sufficient intensity to initiate the main pyrotechnic composition. When voltage is applied to the electric initiator, the wire bridge instantly heats up and ignites the pyrotechnical grease.

In accordance with the second version of the device, information is given hereinunder about the preferred design of the device, which is not intended to limit the amount of protection requested, as defined by the characteristics of an independent formula item.

FIG. 2 shows a diagram and layout version of an autonomous well killing device with fire-fighting function, which allows to solve the problem of prompt well killing and, in case of fire, of autonomous unmanned extinguishing, where 1 is the device body (vessel), 2 is the killing and extinguishing liquid, 3—a gas-generating element (GGE), 4—pyrotechnical gas-generating composition, 5—mechanical GGE initiator, 6—pyrotechnic initiator, 7—thermosensitive element, 8—fire signal transmission line from the thermosensitive element to the pyrotechnic initiator, 9—connecting nipple, 10—pressure release valve, 11—pressure regulator, 12—fire monitor, 13—fire monitor pressure hose.

In case of fluid kick at the wellhead, the working staff can shut off the preventer; however, it is still necessary to kill the well as soon as possible. This is especially true at remote wellheads, where access to special equipment, in particular, to LIA-320 cementing units and tanks with killing liquid, is difficult or impossible. Having decided on the prompt killing of a well, in order to prevent the development of an emergency situation, the personnel may come to the autonomous well killing device with fire-fighting function and manually initiate the mechanical GGE initiator (5), for example, by relieving the shear pin (not shown on FIG. 2). After the shear pin (not shown on FIG. 2) is relieved, the mechanical GGE initiator (5) is started forming a fire pulse to initiate the pyrotechnical gas-generating composition (4) located inside at least one gas-generating element (GGE) (3). During the combustion of the pyrotechnical gas-generating composition (4), there is an intense release of gases (10-20 seconds) that fill the device body (vessel) (1) containing killing and fire extinguishing liquid (2). When the device body (vessel) (1) is filled with gases, the pressure inside it rises, for example, in the range from 1.0 MPa to 20.0 MPa, depending on the values of the required back pressure to create the necessary force when killing the well. Pressure in the device body (vessel) (1) is regulated by means of the pressure release valve (10), which is pre-set to the required shutoff pressure within the range, for example, from 1.0 MPa to 20.0 MPa. During pressure increase in the device body (vessel) (1), the well killing fluid (2) begins to flow through the connecting nipple (9), for example, along the manifold line (not shown in FIG. 2), into the preventer, creating back pressure to the fluid and filling the wellbore space with killing and fire extinguishing fluid (2). The volume of killing and fire extinguishing fluid fed to the well can be, for example, in the range from 1.0 m³ to 20.0 m³

If it was not possible to close the preventer during the emergency situation and the fluid ejected from the well through the preventer under pressure has ignited, a pre-installed thermosensitive element (7) connected to a pyrotechnic initiator (6) via a fire pulse transmission line (8) is triggered in the area of preventer location. Fire pulse rate can reach the speed of e.g. 2000-4000 meters per second. The ignition temperature of the thermosensitive element (7) can be, for example, 173° C. After the fire pulse is transmitted to the pyrotechnic initiator (6), the pyrotechnical composition (4) ignites in at least one gas-generating element (GGE) (3). During the combustion of the pyrotechnical gas-generating composition (4), there is an intense release of gases (within 10-20 seconds) that fill the device body (vessel) (1) containing killing and extinguishing fluid (2). When the device body (vessel) (1) is filled with gases, the inside pressure rises, for example, in the range from 1.0 MPa to 20.0 MPa, depending on the values of the required back pressure to create the necessary force to extinguish the well. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing fluid (2) performs the functions of the fire extinguishing agent (FEA) and flows through the connecting nipple (9), for example, along the manifold line (not shown in FIG. 1) into the preventer, creating back pressure to the fluid, interrupting the release of the fluid through the open channel of the preventer (not show in FIG. 1) and filling the inner volume of the preventer, which leads to guaranteed extinguishing of the well. The volume of the killing fluid acting as the fire extinguishing agent (FEA) supplied to the well for extinguishing can be, for example, in the range from 1.0 m³ to 20.0 m³. The intensity of supply of the killing and extinguishing liquid (2), which performs the function of the fire extinguishing agent (FEA), supplied to the well to be killed can be, for example, in the range from 0.1 m³ to 0.5 m³ per second.

In a situation where manual extinguishing of the wellhead or equipment around the well or a camp is required (FIG. 2), after pressure in the device body (vessel) (1) has risen, it is possible to open the pressure regulator (11) to create an operating pressure, for example, in the range from 0.4 MPa to 1.0 MPa, in the fire monitor (12) and the pressure hose of the fire monitor (13) that is, for example, 30 meters long. The pressure regulator (11) is used to reduce the pressure created in the device body (vessel) (1), for example, in the range from 1.0 MPa to 20.0 MPa, to the maximum pressure in the fire monitor pressure hose (13) and the fire monitor (12), for example, not more than 1.0 MPa.

The device in the second version additionally contains an electrical initiator. It should be noted that the electric initiator looks like a bridge in the form of a thin wire made of metal with high resistance, attached to the contacts of the electric initiator, which is coated with a pyrotechnical grease that can easily ignite when heated and is able to give a thermal pulse of sufficient intensity to initiate the main pyrotechnic composition. When voltage is applied to the electric initiator, the wire bridge instantly heats up and ignites the pyrotechnical grease.

In accordance with the third version of the device, information is given hereinafter about the preferred design of the device, which is not intended to limit the amount of protection requested, as defined by the characteristics of an independent formula item.

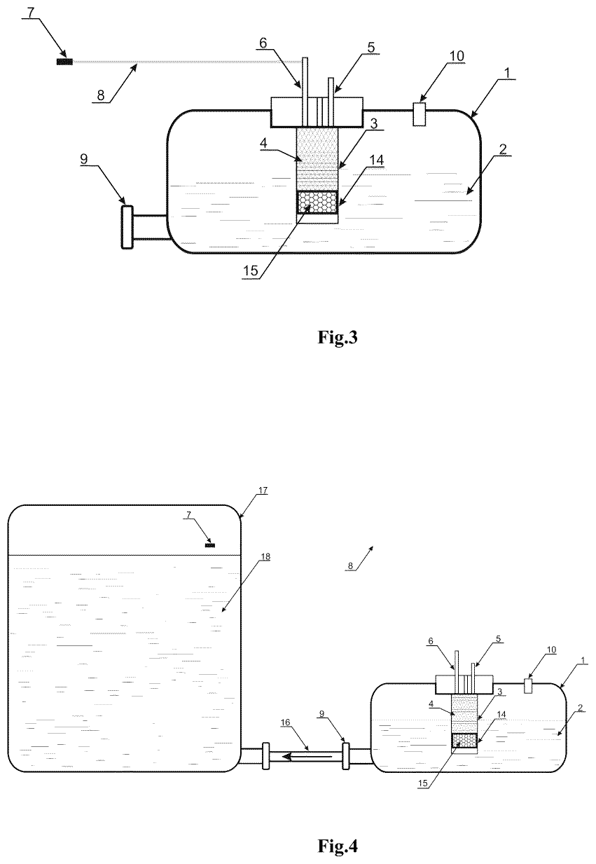

FIG. 3 shows a diagram and layout version of an autonomous well killing device with fire-fighting function, which allows to solve the problem of prompt well killing and, in case of fire, of autonomous unmanned extinguishing, as well as prompt extinguishing of tanks with petroleum-containing fluids or petroleum products where 1 is the device body (vessel), 2 is the killing and extinguishing liquid, 3—a gas-generating element (GGE), 4—pyrotechnical gas-generating composition, 5—mechanical GGE initiator, 6—pyrotechnic initiator, 7—thermosensitive element, 8—fire signal transmission line from the thermosensitive element to the pyrotechnic initiator, 9—connecting nipple, 10—pressure release valve, 11—pressure regulator, 12—fire monitor, 13—fire monitor pressure hose, 14—compartment for surface active agents (SAA), 15—surface active agents (SAA), 16—pressure line, 17—petroleum products storage tank, 18—petroleum products.

In case of fluid kick at the wellhead, the working staff can shut off the preventer; however, it is still necessary to kill the well as soon as possible. This is especially true at remote wellheads, where access to special equipment, in particular, to LIA-320 cementing units and tanks with killing liquid, is difficult or impossible. Having decided on the prompt killing of a well, in order to prevent the development of an emergency situation, the personnel may come to the autonomous well killing device with fire-fighting function and manually initiate the mechanical GGE initiator (5), for example, by relieving the shear pin (not shown on FIG. 3). After the shear pin (not shown on FIG. 3) is relieved, the mechanical GGE initiator (5) is started forming a fire pulse to initiate the pyrotechnical gas-generating composition (4) located inside at least one gas-generating element (GGE) (3). During the combustion of the pyrotechnical gas-generating composition (4), there is an intense release of gases (10-20 seconds) that enter the SAA compartment (14) and intensively press out SAA (15) into the device body (vessel) (1), at the same time actively mixing SAA (15) with the killing and fire extinguishing fluid (2) raising the pressure in the device body (vessel) (1). When the device body (vessel) (1) is filled with gases, the pressure inside it rises, for example, in the range from 1.0 MPa to 20.0 MPa, depending on the values of the required back pressure to create the necessary force when killing the well. Pressure in the device body (vessel) (1) is regulated by means of the pressure release valve (10), which is pre-set to the required shutoff pressure within the range, for example, from 1.0 MPa to 20.0 MPa. During pressure increase in the device body (vessel) (1), the well killing fluid (2) mixed with SAA (15) begins to flow through the connecting nipple (9), for example, along the manifold line (not shown in FIG. 3), into the preventer, creating back pressure to the fluid and filling the wellbore space with killing and fire extinguishing fluid (2) mixed with SAA (15). The volume of killing and fire extinguishing fluid fed to the well can be, for example, in the range from 1.0 m³ to 20.0 m³

If it was not possible to close the preventer during the emergency situation and the fluid ejected from the well through the preventer under pressure has ignited, a pre-installed thermosensitive element (7) connected to a pyrotechnic initiator (6) via a fire pulse transmission line (8) is triggered in the area of preventer location. Fire pulse rate can reach the speed of e.g. 2000-4000 meters per second. The ignition temperature of the thermosensitive element (7) can be, for example, 173° C. After the fire pulse is transmitted to the pyrotechnic initiator (6), the pyrotechnical composition (4) ignites in at least one gas-generating element (GGE) (3). During the combustion of the pyrotechnical gas-generating composition (4), there is an intense release of gases (10-20 seconds) that enter the SAA compartment (14) and intensively press out SAA (15) into the device body (vessel) (1), at the same time actively mixing SAA (15) with the killing and fire extinguishing fluid (2) raising the pressure in the device body (vessel) (1). When the device body (vessel) (1) is filled with gases, the inside pressure rises, for example, in the range from 1.0 MPa to 20.0 MPa, depending on the values of the required back pressure to create the necessary force to extinguish the well. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing fluid (2) mixed with the SAA (15) performs the functions of the fire extinguishing agent (FEA) and flows through the connecting nipple (9), for example, along the manifold line (not shown in FIG. 4) into the preventer, creating back pressure to the fluid, interrupting the release of the fluid through the open channel of the preventer (not show in FIG. 3) and filling the inner volume of the preventer, which leads to guaranteed extinguishing of the well. The volume of the killing fluid acting as the fire extinguishing agent (FEA) supplied to the well for extinguishing can be, for example, in the range from 1.0 m³ to 20.0 m³. The intensity of supply of the killing and extinguishing liquid (2), which performs the function of the fire extinguishing agent (FEA), supplied to the well to be killed can be, for example, in the range from 0.1 m³ to 0.5 m³ per second.

In a situation where manual extinguishing of the wellhead or equipment around the well or a camp is required (FIG. 5), after pressure in the device body (vessel) (1) has risen, it is possible to open the pressure regulator (11) to create an operating pressure, for example, in the range from 0.4 MPa to 1.0 MPa, in the fire monitor (12) and the fire monitor pressure hose (13) that is, for example, 30 meters long, to supply the mixture of the killing and extinguishing fluid (2) with the SAA (15). The pressure regulator (11) is used to reduce the pressure created in the device body (vessel) (1), for example, in the range from 1.0 MPa to 20.0 MPa, to the maximum pressure in the fire monitor pressure hose (13) and the fire monitor (12), for example, not more than 1.0 MPa.

When an autonomous well killing device with fire-fighting function is connected to the pressure line (16) of the petroleum products storage tank (17) (FIG. 5), it is possible to extinguish the petroleum products storage tank (17) in autonomous or manual mode, with no electrical signals and unmanned.

If, during an accident, a fire occurs at the petroleum products storage tank (17), a pre-installed thermosensitive element (7) connected to a pyrotechnic initiator (6) via a fire pulse transmission line (8) is triggered in the control areas on the surface of the protected petroleum products storage tank (17). Fire pulse rate can reach the speed of e.g. 2000-4000 meters per second. The ignition temperature of the thermosensitive element (7) can be, for example, 173° C. After the fire pulse is transmitted to the pyrotechnic initiator (6), the pyrotechnical composition (4) ignites in at least one gas-generating element (GGE) (3). During the combustion of the pyrotechnical gas-generating composition (4), there is an intense release of gases (10-20 seconds) that enter the SAA compartment (14), which is an integral part of the GGE body (3) and contains SAA (15) and a mechanism for releasing SAA (15) with increasing pressure (not indicated in the figure, can be provided in the form of a rupture plate of elastic material) and intensively press out SAA (15) into the device body (vessel) (1), at the same time actively mixing SAA (15) with the killing and fire extinguishing fluid (2) raising the pressure in the device body (vessel) (1). It should be noted that by SAA (15) we mean surface active agents that create a fire-extinguishing emulsion or fire-extinguishing foam together with water, made, for example, on a synthetic, fluorosynthetic, protein and fluoroprotein basis. When the device body (vessel) (1) is filled with gases, the inside pressure rises, for example, in the range from 1.0 MPa to 20.0 MPa, depending on the required parameters. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing fluid (2) mixed with the SAA (15) performs the functions of the fire extinguishing agent (FEA) and flows through the connecting nipple (9), for example, along the pressure line (16) into the lower part of the protected petroleum products storage tanks (17). Killing and fire extinguishing fluid (2) mixed with surfactants (15) has density lower than petroleum products (18) in a petroleum products storage tank (17), which leads to a rise of the killing and fire extinguishing fluid (2) and SAA (15) level, creating a protective film on the surface of burning petroleum products. Due to the mixture of killing and extinguishing fluids (2) and SAA (15) spreading over the entire surface of the petroleum product (18), an intensive suppression of flame occurs.

The intensity of the supply of the killing and extinguishing fluid (2) in a mixture with SAA (15) acting as a fire extinguishing agent (FEA) supplied to the petroleum products storage tank (17) via a pressure line (16) for extinguishing can be, for example, in the range from 0.1 m³ to 0.8 m³ per second.

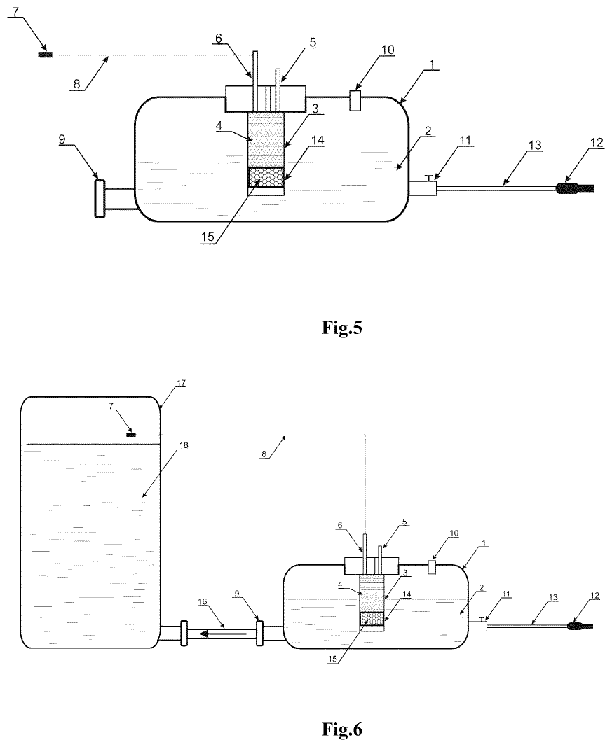

In a situation where manual extinguishing of the petroleum products storage tank (17) or equipment around the petroleum products storage tank (FIG. 6) is required, after pressure in the device body (vessel) (1) has risen, it is possible to open the pressure regulator (11) to create an operating pressure, for example, in the range from 0.4 MPa to 1.0 MPa in the fire monitor (12) and the fire monitor pressure hose (13) that is, for example, 30 meters long, to supply the mixture of killing and extinguishing fluids (2) and SAA (15). The pressure regulator (11) is used to reduce the pressure created in the device body (vessel) (1), for example, in the range from 1.0 MPa to 20.0 MPa, to the maximum pressure in the fire monitor pressure hose (13) and the fire monitor (12), for example, not more than 1.0 MPa.

The device in the third version additionally contains an electrical initiator. It should be noted that the electric initiator looks like a bridge in the form of a thin wire made of metal with high resistance, attached to the contacts of the electric initiator, which is coated with a pyrotechnical grease that can easily ignite when heated and is able to give a thermal pulse of sufficient intensity to initiate the main pyrotechnic composition. When voltage is applied to the electric initiator, the wire bridge instantly heats up and ignites the pyrotechnical grease.

In accordance with the fourth version of the device, information is given hereinafter about the preferred design of the device, which is not intended to limit the amount of protection requested, as defined by the characteristics of an independent formula item.

FIG. 5 shows a diagram and layout version for an autonomous well killing device with fire-fighting function, which allows to solve the problem of prompt well killing and, in case of fire, of autonomous unmanned extinguishing, as well as prompt extinguishing of tanks with petroleum-containing fluids or petroleum products where 1 is the device body (vessel), 2 is the killing and extinguishing liquid, 3—a gas-generating element (GGE), 4—pyrotechnical gas-generating composition, 5—mechanical GGE initiator, 6—pyrotechnic initiator, 7—thermosensitive element, 8—fire signal transmission line from the thermosensitive element to the pyrotechnic initiator, 9—connecting nipple, 10—pressure release valve, 11—pressure regulator, 12—fire monitor, 13—fire monitor pressure hose, 14—compartment for surface active agents (SAA), 15—surface active agents (SAA), 16—pressure line, 17—petroleum products storage tank, 18—petroleum products

In case of fluid kick at the wellhead, the working staff can shut off the preventer; however, it is still necessary to kill the well as soon as possible. This is especially true at remote wellheads, where access to special equipment, in particular, to LIA-320 cementing units and tanks with killing liquid, is difficult or impossible. Having decided on the prompt killing of a well, in order to prevent the development of an emergency situation, the personnel may come to the autonomous well killing device with fire-fighting function and manually initiate the mechanical GGE initiator (5), for example, by relieving the shear pin (not shown on FIG. 3). After the shear pin (not shown on FIG. 3) is relieved, the mechanical GGE initiator (5) is started forming a fire pulse to initiate the pyrotechnical gas-generating composition (4) located inside at least one gas-generating element (GGE) (3). During the combustion of the pyrotechnical gas-generating composition (4), there is an intense release of gases (10-20 seconds) that enter the SAA compartment (14) and intensively press out SAA (15) into the device body (vessel) (1), at the same time actively mixing SAA (15) with the killing and fire extinguishing fluid (2) raising the pressure in the device body (vessel) (1). When the device body (vessel) (1) is filled with gases, the pressure inside it rises, for example, in the range from 1.0 MPa to 20.0 MPa, depending on the values of the required back pressure to create the necessary force when killing the well. Pressure in the device body (vessel) (1) is regulated by means of the pressure release valve (10), which is pre-set to the required shutoff pressure within the range, for example, from 1.0 MPa to 20.0 MPa. During pressure increase in the device body (vessel) (1), the well killing fluid (2) mixed with SAA (15) begins to flow through the connecting nipple (9), for example, along the manifold line (not shown in FIG. 3), into the preventer, creating back pressure to the fluid and filling the wellbore space with killing and fire extinguishing fluid (2) mixed with SAA (15). The volume of killing and fire extinguishing fluid fed to the well can be, for example, in the range from 1.0 m³ to 20.0 m³.

If it was not possible to close the preventer during the emergency situation and the fluid ejected from the well through the preventer under pressure has ignited, a pre-installed thermosensitive element (7) connected to a pyrotechnic initiator (6) via a fire pulse transmission line (8) is triggered in the area of preventer location. Fire pulse rate can reach the speed of e.g. 2000-4000 meters per second. After the fire pulse is transmitted to the pyrotechnic initiator (6), the pyrotechnical composition (4) ignites in at least one gas-generating element (GGE) (3). During the combustion of the pyrotechnical gas-generating composition (4), there is an intense release of gases (10-20 seconds) that enter the SAA compartment (14) and intensively press out SAA (15) into the device body (vessel) (1), at the same time actively mixing SAA (15) with the killing and fire extinguishing fluid (2) raising the pressure in the device body (vessel) (1). When the device body (vessel) (1) is filled with gases, the inside pressure rises, for example, in the range from 1.0 MPa to 20.0 MPa, depending on the values of the required back pressure to create the necessary force to extinguish the well. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing fluid (2) mixed with the SAA (15) performs the functions of the fire extinguishing agent (FEA) and flows through the connecting nipple (9), for example, along the manifold line (not shown in FIG. 4) into the preventer, creating back pressure to the fluid, interrupting the release of the fluid through the open channel of the preventer (not show in FIG. 3) and filling the inner volume of the preventer, which leads to guaranteed extinguishing of the well. The volume of the killing fluid acting as the fire extinguishing agent (FEA) supplied to the well for extinguishing can be, for example, in the range from 1.0 m³ to 20.0 m³. The intensity of supply of the killing and extinguishing liquid (2), which performs the function of the fire extinguishing agent (FEA), supplied to the well to be killed can be, for example, in the range from 0.1 m³ to 0.5 m³ per second.

When an autonomous well killing device with fire-fighting function is connected to the pressure line (16) of the petroleum products storage tank (17) (FIG. 4) it is possible to extinguish the petroleum products storage tank (17) in autonomous or manual mode, with no electrical signals and unmanned.

If during an accident a fire occurs at the petroleum products storage tank (17), a pre-installed thermosensitive element (7) connected to a pyrotechnic initiator (6) via a fire pulse transmission line (8) is triggered in the control areas on the surface of the protected petroleum products storage tank (17). Fire pulse rate can reach the speed of e.g. 2000-4000 meters per second. The ignition temperature of the thermosensitive element (7) can be, for example, 173° C. After the fire pulse is transmitted to the pyrotechnic initiator (6), the pyrotechnical composition (4) ignites in at least one gas-generating element (GGE) (3). During the combustion of the pyrotechnical gas-generating composition (4), there is an intense release of gases (10-20 seconds) that enter the SAA compartment (14) and intensively press out SAA (15) into the device body (vessel) (1), at the same time actively mixing SAA (15) with the killing and fire extinguishing fluid (2) raising the pressure in the device body (vessel) (1). When the device body (vessel) (1) is filled with gases, the inside pressure rises, for example, in the range from 1.0 MPa to 20.0 MPa, depending on the required parameters. Pressure in the device body (vessel) (1) is regulated by means of a pressure release valve (10), which is pre-set to the required shutoff pressure within the range, for example, from 1.0 MPa to 20.0 MPa. During pressure increase in the device body (vessel) (1), the well killing and extinguishing fluid (2) mixed with the SAA (15) performs the functions of the fire extinguishing agent (FEA) and flows through the connecting nipple (9), for example, along the pressure line (16) into the lower part of the protected petroleum products storage tanks (17). Killing and fire extinguishing fluid (2) mixed with surfactants (15) has density lower than petroleum products (18) in a petroleum products storage tank (17), which leads to a rise of the killing and fire extinguishing fluid (2) and SAA (15) mixture level, creating a protective film on the surface of burning petroleum products. Due to the mixture of killing and extinguishing fluids (2) and SAA (15) spreading over the entire surface of the petroleum product (18), an intensive suppression of flame occurs.

The intensity of the supply of the killing and extinguishing fluid (2) in a mixture with SAA (15) acting as a fire extinguishing agent (FEA) supplied to the petroleum products storage tank (17) via a pressure line (16) for extinguishing can be, for example, in the range from 0.1 m³ to 0.8 m³ per second.

The device in the fourth version additionally contains an electrical initiator. It should be noted that the electric initiator looks like a bridge in the form of a thin wire made of metal with high resistance, attached to the contacts of the electric initiator, which is coated with a pyrotechnical grease that can easily ignite when heated and is able to give a thermal pulse of sufficient intensity to initiate the main pyrotechnic composition. When voltage is applied to the electric initiator, the wire bridge instantly heats up and ignites the pyrotechnical grease.

1. An autonomous well killing device with fire-fighting function, the device comprising:
a body made in the form of a vessel with killing and fire extinguishing fluid and at least one gas-generating element with a pyrotechnical gas-generating charge;
a thermosensitive element connected via a fire signal transmission line to a pyrotechnic initiator, wherein the gas-generating element is designed to create excessive pressure in the body sufficient to press out the killing and extinguishing fluid through the connecting nipple of the body into the wellbore.

2. An autonomous well killing device according to claim 1 further comprising a pressure release valve.

3. An autonomous well killing device according to claim 1 further comprising a pressure regulator, a fire monitor and a fire monitor pressure hose.

4. An autonomous well killing device according to claim 1, wherein the gas-generating element contains a compartment for SAA where SAA are located.

5. An autonomous well killing device according to claim 1 further comprising an electric initiator.

6. An autonomous well killing device according to claim 1 further comprising a mechanical initiator.
